(19) United States
(12) Patent Application Publication
(10) Pub. No.: US 2015/0104156 A1
(43) Pub. Date: Apr. 16, 2015

(54) GENERATING VIDEO DATA WITH A SOUNDTRACK

(71) Applicant: LIFE ON SHOW LIMITED, Newport (GB)

(72) Inventor: Adam James Price, Newport (GB)

(73) Assignee: LIFE ON SHOW LIMITED, Newport (GB)

(21) Appl. No.: 14/395,235

(22) PCT Filed: Mar. 21, 2013
(86) PCT No.: PCT/GB2013/050740

§ 371 Date: Oct. 17, 2014

(30) Foreign Application Priority Data
Apr. 18, 2012 (GB) 1206779.9

(51) Int. Cl. G11B 27/036

(52) U.S. Cl. CPC G11B 27/036
USPC 386/285

(57) ABSTRACT

A method of generating video data with a soundtrack (114), the method including: receiving (204) video data (112) relating to a product or service; obtaining (208, 212) descriptive data relating to the product or service; generating (214, 216) audio data based on the descriptive data; adding (218) the audio data as a soundtrack to at least part of the video data, and storing (220) and/or playing the video data with the added soundtrack. The invention also includes a system configured to use the method and a related computer program element.

This invention relate to generating video data with a soundtrack.

The use of digital content including video is becoming increasingly important as internet-based services move towards a more media-led audience. Video is becoming more and more common as the way the internet delivers content and so in order for search engines to deliver accurate and targeted results, they cover visual and audio information included in video content. Video-based services, such as YouTube™ already have the ability to analyse audio from submitted video content and can use this technology to manage rights protected music and it is expected that other general World-Wide Web (WWW) search engines will also provide such functionality. Thus, search engines will be able to decide what content is relevant for given searches based on the audio content of videos and then deliver blended (both text and video) targeted results to the user, based on their search criteria.

Video content is not always available for some products/services, which can put the providers or sellers of such products/services at a disadvantage when it comes to video-based searching. Traditionally, producing video content is time consuming and expensive. In other cases, video content may be available, but does not include any descriptive audio information (e.g. a musical soundtrack only) that can help search engines return it as a relevant result. Conventionally, voice-over artists have been used to add such descriptive audio content to videos, which, again, tends to be time-consuming and expensive.

Embodiments of the present invention are intended to address at least some of the problems discussed above. Embodiments of the present invention can automatically bring separate services together in order to automate and speed up delivery of video content that will be able to be found in video-based search engines. In many embodiments of the present invention, the whole video generation process is automated and the system is able to produce descriptive audio data and embed it in a video within in seconds.

According to a first aspect of the present invention there is provided a method of generating video data with a soundtrack, the method including or comprising:

receiving video data relating to a product or service;

obtaining descriptive data relating to the product or service;

generating audio data based on the descriptive data;

adding the audio data as a soundtrack to at least part of the video data, and

storing and/or playing the video data with the added soundtrack.

The method may include performing image analysis on at least one frame of the video data in order to obtain an identifier relating to the product or service. For example if the product is a vehicle then the method may include applying an image analysis technique to identify a number or licence plate (or any other similar identifier) of the vehicle. The step of obtaining descriptive data may then include searching a database of vehicles using the identifier and retrieving information relating to a vehicle matching the identifier, e.g. model specification. If the step of performing image analysis does not result in an identifier being obtained then the method can include obtaining user input relating to an identifier or the product or service.

The method may include producing text or a sentence based on the descriptive data. The step of generating audio data can include generating speech based on the produced text or the sentence.

The video data with the added soundtrack can be saved as a file, the file having a name that includes at least some of the descriptive data.

The method may include selecting the audio data from a plurality of available sets of data. The sets of data may include audio data in different languages or audio data representing different marketing messages, for instance.

According to another aspect of the present invention there is provided a computer program element comprising: computer code means to make the computer execute a method substantially as described herein. The element may comprise a computer program product.

According to an alternative aspect of the present invention there is provided a method of adding a soundtrack to video data, the method including or comprising:

receiving video data relating to a product or service;

obtaining descriptive data relating to the product or service;

generating audio data based on the descriptive data;

playing back the audio data as a soundtrack along with at least part of the video data.

According to yet another aspect of the present invention there is provided a system configured to generate video data including a soundtrack, the system including or comprising:

a device configured to receive video data relating to a product or service;

a device configured to obtain descriptive data relating to the product or service;

a device configured to generate audio data based on the descriptive data;

a device configured to add the audio data as a soundtrack to at least part of the video data, and

a device configured to store and/or play the video data with the added soundtrack.

An embodiment of the present invention will now be described, by way of example only, and with reference to the accompanying drawings, in which:

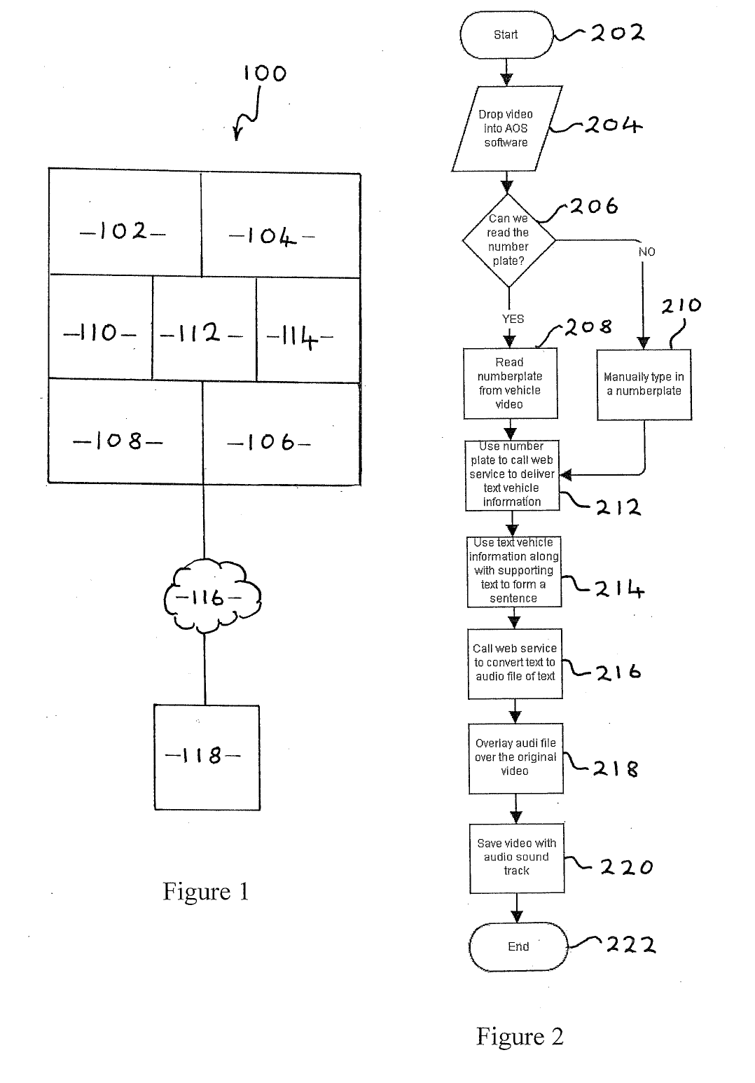

FIG. 1 is a block diagram of a computing system configured according to an embodiment of the invention, including a computing device running an application, and

FIG. 2 is a flowchart showing example steps performed by the application.

FIG. 1 shows an example computing device 100 having a processor 102 and a memory 104. The computer also includes other standard components, such as a user interface 106 and a communications interface 108. The memory 104 of the computing device 100 includes an application 110 that is intended to process video data 112 in order to produce data 114 that comprises video data with a soundtrack. The communications interface 108 of the computer allows it to communicate over a network, including the internee 116, with at least one remote computing device 118.

Typically, a user of the computing device 100 will launch the application 110 and bad video data 112 into it, e.g. by downloading a video file/stream from a removable storage medium, such as a DVD, memory stick or camera, or from a remote source via the internet 116. The application then processes the data file, which can include obtaining further data from a remote source/service via the internet or locally, in order to produce the video with soundtrack data 114. The data 114 can then be used in any suitable manner, e.g. transferred over the internet and uploaded onto a suitable website or made accessible to search engines in some other way.

FIG. 2 illustrates steps that can be performed by an example embodiment of the application 110. The skilled person will understand that the steps can be coded using any suitable programming language and/or data structures. It will also be understood that in alternative embodiments some of the steps may be omitted and/or re-ordered. The example application relates to a service for selling cars/vehicles, but it will be appreciated that many other uses for a system based upon the present invention are possible.

The application 110 starts operating at step 202, typically when a user of the computing device 100 launches it. Standard security steps, such as authenticating the user, etc, may be required. The application may comprise a graphical user interface which is designed to be as simplistic and minimalistic as possible. At step 204 video data 112 is loaded into the application. This can be done in various ways, for instance, by selecting a file from a storage medium, such as a DVD or a hard drive of the computing device, or by selecting a video from ones that are downloadable from a website, or a live feed from a camera. In the example embodiment, the video shows a vehicle that is to be sold. In some cases, the video may comprise an orbital view of a vehicle produced by the system described in the present inventors' International patent application no. PCT/GB2012/000232, filed on 9 Mar. 2012, the contents of which are hereby incorporated by reference. Further, the video/soundtrack generation method described herein earl be incorporated as (an optional) part of that earlier system.

At step 206, the application 110 analyses at least part of the video data 112 in order to try to find information that can identify the vehicle shown in the video. In one embodiment, the application seeks to read the number/licence plate of the vehicle shown in the video, although it will be understood that other unique identifiers may be used on the outside of the target vehicle in the absence of a number plate, such as a randomly generated number with sufficient digits to make accidental duplication unlikely. Extraction of still images from the video data may be performed during this processing stage and the application may use conventional number recognition equipment, such as that available at www.ndi-rs.com. In other embodiments, the system may analyse at least one image of the vehicle to try to determine its manufacturer/model, either by recognising insignia on the bodywork, or by comparing the shape or other features of the vehicle against a database of vehicle design information.

The application 110 therefore provides the ability to extract the vehicle's registration details directly from the video data 112 at step 208. As image recognition is a difficult field of research, and detection of letters and symbols is not currently 100% reliable, the invention preferably incorporates validation algorithms to increase the reliability of the recognition system. Traditionally, license plate recognition is performed on a single source image and the success of the operation is dependent upon multiple factors such as the resolution of the image, image formal and image dimension, the angle of the license plate relative to the camera, distance of plate from lens and font use on license; and external factors such as lever of lighting, cleanliness of plate, etc. In some embodiments, the user may be prompted to visually check that the license plate determined by the recognition software corresponds to that of the vehicle.

In another embodiment, multiple still views of the vehicle may be extracted from the video data 112, which show the vehicle at varying angles, of Which some, say 4, will include the vehicle number plate. The number of sample attempts may be specified (stored) in the system configuration file as determined by the user. Upon completion of a number of attempted recognitions, a plurality of results and confidence levels are analysed by the system and amalgamated into a ‘global’ confidence level. Should this level be above a predefined metric level, confidence that the registration matches the vehicle registration increases.

If the application 110 is unable to determine the number plate of the vehicle at step 206 then control passes to step 210, where the user is prompted to input the identifier data manually.

Upon automated or manual input of the registration number at step 208 or 210, respectively, other data relating to the vehicle may be user inputted (or retrieved from another source) in some cases, e.g. the recorded mileage of the vehicle, details of non-standard equipment, condition information, etc. At step 212, a web service call can be made to retrieve data from at least one external source (e.g. a national number plate/vehicle database) for that vehicle registration automatically. Examples of the data that can he obtained includes the make, model, colour, etc. For example: identifier VF07EDK=Audi, A4, Convertible, Black, etc.

At step 214, the application 110 uses the data relating to the vehicle obtained at step 212 to generate descriptive text. This can he done in an algorithmic manner by means of a remote resource, such as www.NDI-RS.com. The processing may involve identifying at least one feature of the descriptive data and inserting this/these into a template sentence. For instance, for the vehicle having the registration VF07EDK given as an example above, the method may use this information in combination with a template to produce at least one sentence (features based on retrieved information shown in italics) “A March 2007 plate Audi A4 Convertible having a 2.0 litre engine. The colour of the vehicle is black.” It will be understood that alternative/additional information could be used, e.g. colour, mileage, non-standard equipment, subjective comments on condition, etc. It will also be understood that an option to manually add text using a text editor may be provided and text entered this way can also be surrounded by formatted text to form a sentence.

At step 218, the application 110 uses the descriptive text data produced at step 214 to generate audio data corresponding to the description. This can be done using known text-to-speech generation techniques and may involve use of a remote web-based service, such as www.SitePal.com (which can in some cases include an optional visual avatar). The audio data may correspond exactly to the text/description produced at step 214, or some alteration may be applied to it, e.g. extended intervals inserted between sentences in order to better match the duration of the video clip, etc.

At step 218, the audio data generated at step 216 is added to/overlaid onto at least part of the video data 112. This can be done using standard techniques. For example, if the audio generated at step 216 is in the form of MP3 data and the video data is in the form of MP4 data then the MP3 audio file can be merged with the MP4 video file and the resulting combined MP4 video file saved, meaning that the system has generated a soundtrack and overlaid in onto a single MP4 file. Alternatively, the MP3 audio file may be joined with the MP4 video file at run time, providing the facility to alter the audio when required, which means that the same video can be used with no requirement to generate and store multiple videos with different audio tracks. This can provide the facility to translate the text into different languages for a global reach, or have different marketing messages depending on where the video is being seen, e.g. B2C or B2B environments. It will be understood that alternative audio/video data formats can be used. Some alteration of the audio data may be applied, e.g. addition of a standard introduction/contact details voice-over, sound effects and/or music, etc.

At step 220, the application 110 saves the video data with the soundtrack added at step 218 as data 114. Preferably, some of the descriptive data may be used in the file name. For instance, if the vehicle was identified as a BMW 535 then the file name can include “bmw_{—}535”. This can further improve the chances of the video data being found by a search engine. This data can be stored and used by the application 110 in any suitable manner, which can include passing them to an uploader module of the application for uploading to a media server along with any other relevant content for access by potential customers and/or search engines. In alternative embodiments, the video data and the audio data generated at step 216 may be stored and retrieved separately but played back simultaneously/in synch, with such simultaneous playback constituting adding of the audio data as a soundtrack to the video data. After this, the operation of the application can end at step 222.

The skilled person will appreciate that many variations and optional features may be provided by the application 110. User settings may be accessed via a drop-down menu provided on a menu bar or the like. Such settings may include a choice of video formats which may be used. Other settings may also be included and the invention is not intended to be limited in this regard. It will also be understood that the type(s) of product or services with which the system is used can differ from the detailed example above. For instance, an embodiment may be provided for assisting with marketing property by generating a description/soundtrack relating to location, surrounding facilities such as local schools, property details such as number of bedrooms, bathrooms and/or garages, etc. Another example is bathroom products, where the system can generate product description, e.g. “Flush shower tray with stainless steel fittings”, etc.

Thus, embodiments of the invention provide an automated method of generating video data with a soundtrack, with little/no human interaction required. The method is much faster and cost-effective than conventional video production techniques, with the additional benefit that the resulting audio information included with the video data can be retrieved by suitable search engines.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of’ and “comprising” means “including or consisting of’. The singular reference of an element does not exclude the plural reference of such elements and vice-versa. The invention may be implemented by means of hardware comprising several distinct elements and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A method of generating video data with a soundtrack (114), the method including:
receiving (204) video data (112) relating to a product or service;
obtaining (208, 212) descriptive data relating to the product or service;
generating (214, 218) audio data based on the descriptive data;
adding (218) the audio data as a soundtrack to at least part of the video data, and storing (220) and/or playing the video data with the added soundtrack.

2. A method according to claim 1, including performing image analysis (208) of at least one frame of the video data (112) in order to find an identifier relating to the product or service.

3. A method according to claim 2, wherein the product is a vehicle and the method includes performing (208) the image analysis technique to at least one frame of the video data to obtain the identifier (e.g. a number or licence plate) for the vehicle.

4. A method according to claim 3, wherein the step of obtaining (212) descriptive data includes searching a database of vehicles using the identifier and retrieving information (e.g. model specification) relating to a vehicle matching the identifier.

5. A method according to claim 2, wherein if the step of performing image analysis does not result in an identifier being found then the method includes obtaining (210) user input relating to an identifier for the product or service.

6. A method according to claim 1, including producing (214) text or a sentence based on the descriptive data.

7. A method according to claim 6, wherein the step of generating audio data includes generating (216) speech based on the produced text or the sentence.

8. A method according to claim 1, wherein the video data with the added soundtrack is saved as a file, the file having a name that includes at least some of the descriptive data.

9. A method according to claim 1, further including selecting the audio data from a plurality of available sets of data.

10. A method according to claim 9, wherein the sets of data may include audio data in different languages, or audio data representing different marketing messages.

11. A computer program element comprising: computer code means to make the computer execute a method according to any one of the preceding claims.

12. A system configured to generate video data (114) including a soundtrack, the system including:
a device (100) configured to receive video data (112) relating to a product or service;
a device (100) configured to obtain descriptive data relating to the product or service;
a device (100) configured to generate audio data based on the descriptive data;
a device (100) configured to add the audio data as a soundtrack to at least part of the video data, and
a device (100) configured to store and/or play the video data with the added soundtrack.
